(19) United States
(12) Patent Application Publication
(10) Pub. No.: US 2025/0304364 A1
(43) Pub. Date: Oct. 2, 2025

(54) Trash Can

(71) Applicant: Clark Core Services, LLC, Lancaster, PA (US)

(72) Inventors: Zachary William Jenkins, Douglassville, PA (US); Luke Hursh, Holtwood, PA (US); Krystal M. Cherif, New Cumberland, PA (US)

(73) Assignee: Clark Core Services, LLC, Lancaster, PA (US)

(21) Appl. No.: 18/909,008

(22) Filed: Oct. 8, 2024

Related U.S. Application Data
(60) Provisional application No. 63/570,895, filed on Mar. 28, 2024.

(51) Int. Cl. B65F 1/14; B65F 1/06

(52) U.S. Cl. CPC B65F 1/1452; B65F 1/06

(57) ABSTRACT

A receptacle having a side wall. The receptacle further having a bottom wall coupled to the side wall forming a receiving space. The receptacle further includes a handle positioned on opposing sides of the side wall. The handle having a cinch with a locking mechanism on a perimeter of the cinch.

### CROSS-REFERENCE TO RELATED APPLICATIONS

This application claims priority under 35 U.S.C. § 119 to U.S. Provisional Patent Application No. 63/570,895 filed Mar. 28, 2024.

### FIELD OF THE INVENTION

The present invention pertains to a trash can and, more particularly, to a trash can with an improved cinch.

### BACKGROUND

Generally, designs for trash cans are in the public domain. However, there is a need for an effective trash can design that includes a unique handle design and bag cinch area to rectify the deficiencies of the present trash can designs.

### SUMMARY

A receptacle having a side wall. The receptacle further having a bottom wall coupled to the side wall forming a receiving space. The receptacle further includes a rim extending around a perimeter of the side wall. The receptacle further includes a handle positioned on opposing sides of the side wall. The handle having a cinch with a locking mechanism on a perimeter of the cinch.

### BRIEF DESCRIPTION OF DRAWINGS

In the following, the present invention is described in more detail with references to the drawings in which:

FIG. 1 illustrates a front, top, left side perspective view of an exemplary embodiment of the invention;

FIG. 2 illustrates a rear, bottom, right side perspective view of the FIG. 1;

FIG. 3 illustrates a front perspective view;

FIG. 4 illustrates a right side perspective view;

FIG. 5 illustrates a top perspective view;

FIG. 6 illustrates a bottom perspective view;

FIG. 7 illustrates an enlarged view of a cinch of the invention;

FIG. 8 illustrates a front perspective view;

FIG. 9 illustrates another front perspective view of FIG. 8; and

FIG. 10 illustrates another front perspective view of FIG. 9.

### DETAILED DESCRIPTION OF THE EMBODIMENTS

With reference to the Figures, a trash can 1 according to the invention is shown. In an exemplary embodiment shown, a trash can 1 according to the invention generally includes a container 2 and a handle 4.

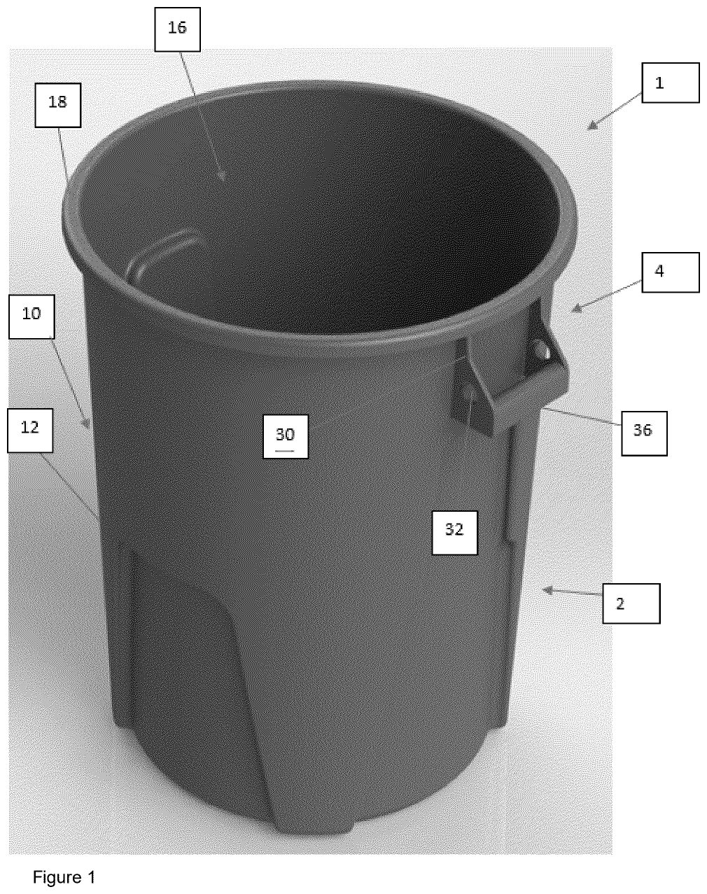

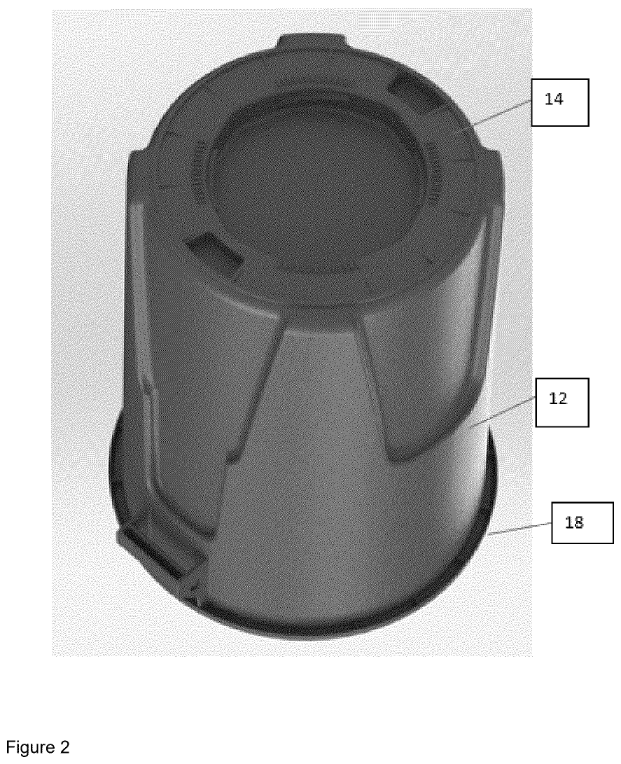

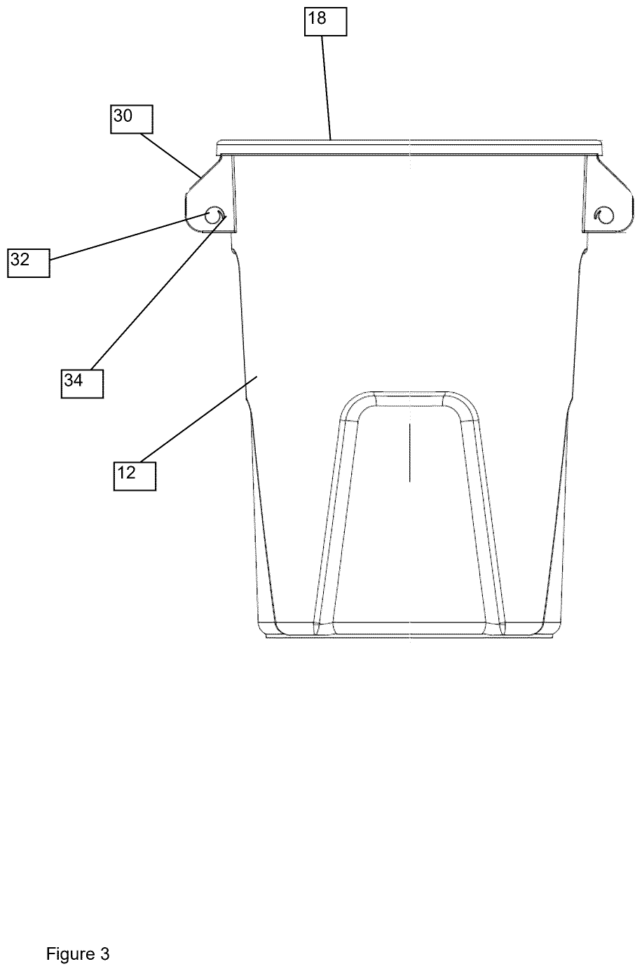

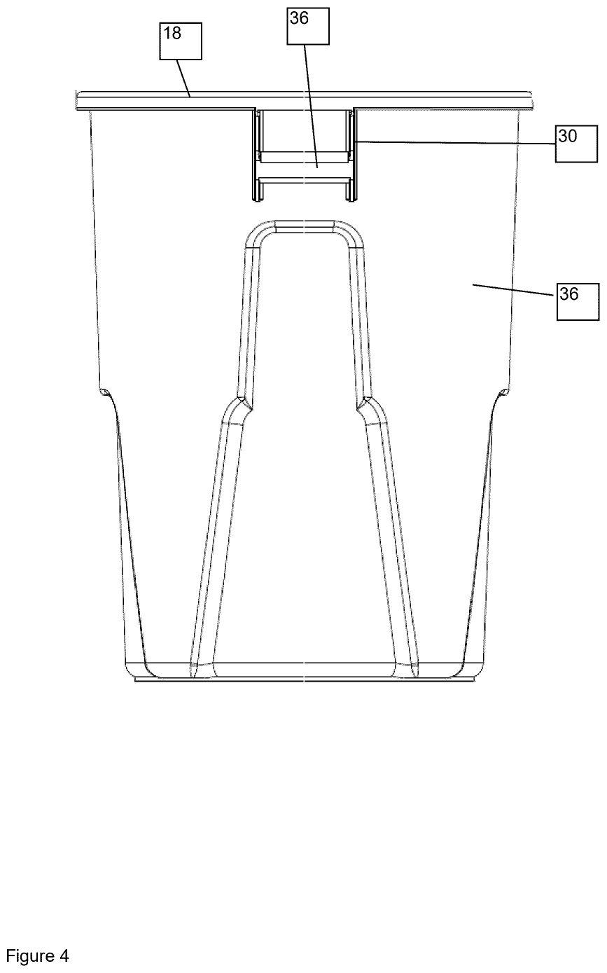

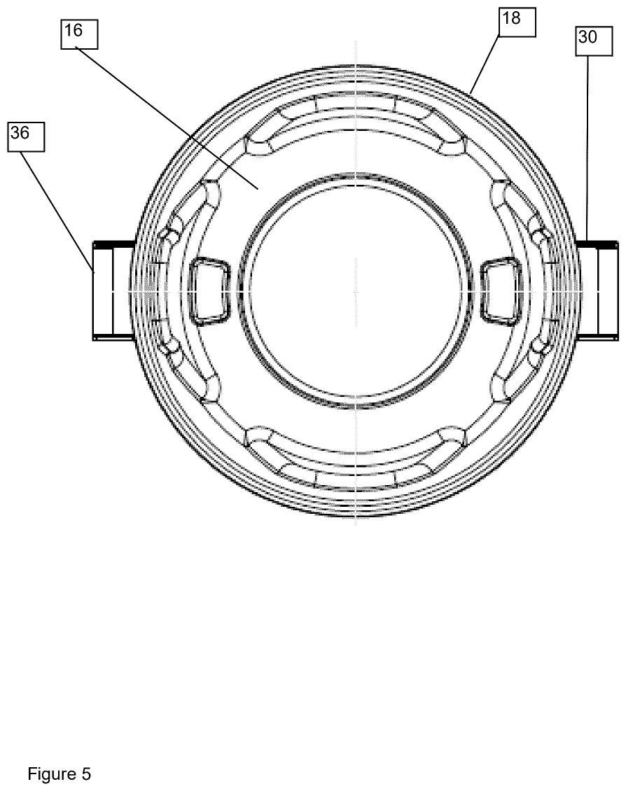

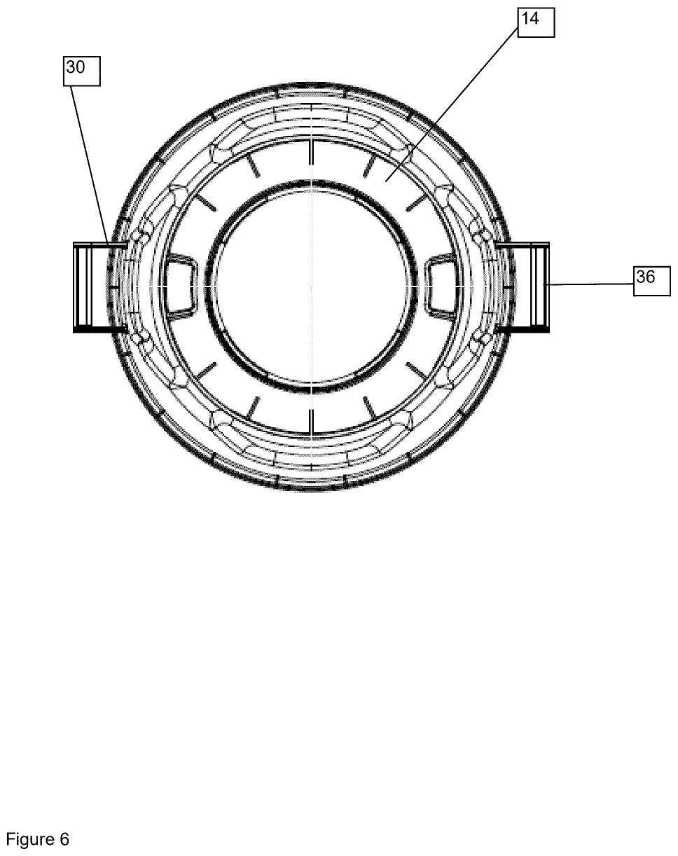

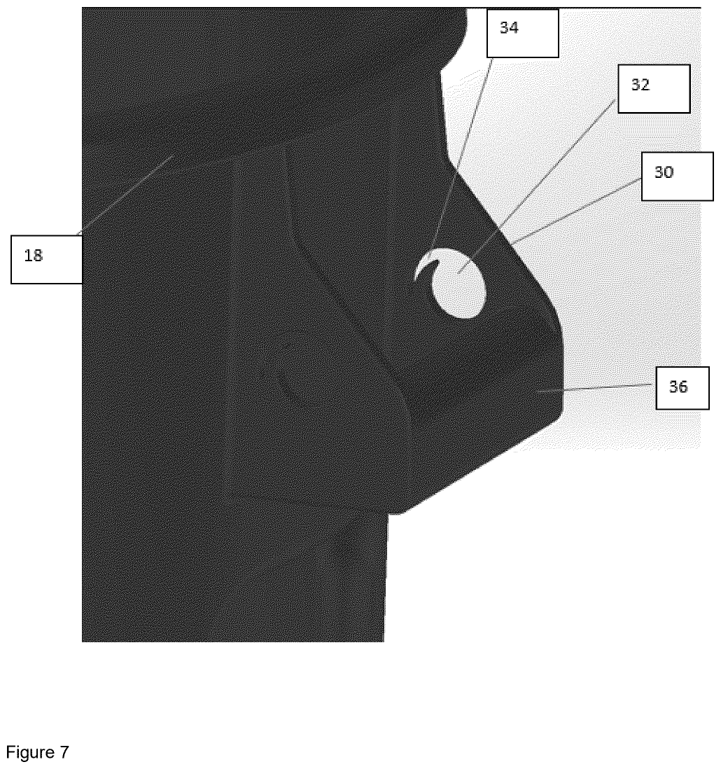

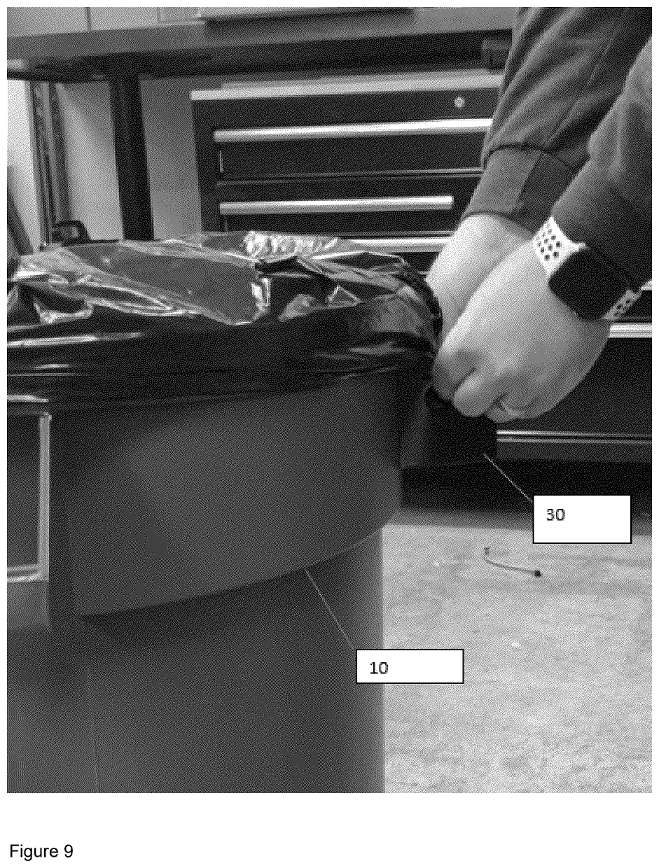

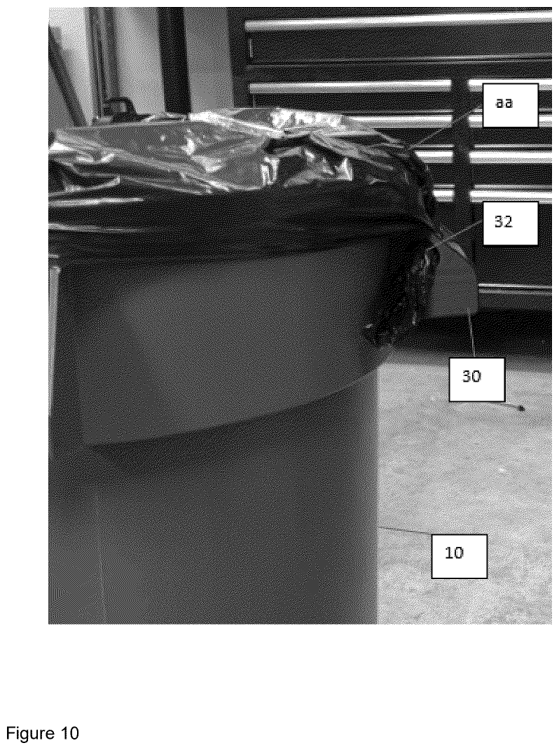

With reference to FIGS. 1-10, an exemplary embodiment of the container 2 is shown and generally includes a body 10. The body 10 is conical. One skilled in the art would understand the applicant's design is not the exclusive embodiment.

The body 10 further includes a side wall 12 and a bottom wall 14. The side wall 12 and the bottom wall 14 form a receiving space 16. The receiving space 16 permits a liner aa to rest within the receiving space 16. The body 10 further includes a rim 18. The rim 18 extends around a perimeter of the body 10.

In the exemplary embodiment, the handle 4 is disposed on the side wall 12 of the body 10. Specifically, a portion of the handle 4 is positioned under and within the rim 18. One skilled in the art would understand the applicant's design is not the exclusive embodiment. In another exemplary embodiment, there are at least two handles 4 disposed on the side wall 12.

In the exemplary embodiment, the handle 4 includes a pair of side walls 30. The pair of side walls 30 are elongated plate members and taper towards the rim 18. One skilled in the art would understand the applicant's design is not the exclusive embodiment.

Each side wall 30 further includes a cinch 32. The cinch 32 is circular and extends through the side wall 30. The cinch 32 further includes a locking mechanism 34 positioned at one end of the cinch 32 forming a wave shape formation within the cinch 32. Specifically, the locking mechanism 34 is a receiving space on a perimeter of the cinch 32.

The handle 4 further includes a grip 36. The grip 36 is a cylindrical rod member extending between each side wall 30 and coupling the side walls 30 together. One skilled in the art would understand the applicant's design is not the exclusive embodiment.

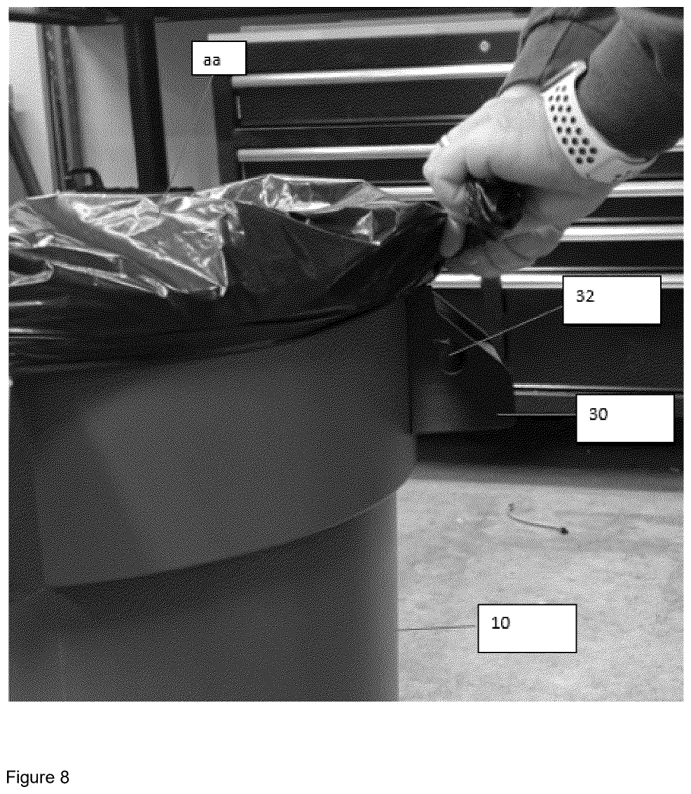

In the exemplary embodiment and as shown in FIGS. 8-10, a user will position a liner aa over the rim 18 of the body 10. The user will then twist a portion of the liner aa and thread the liner aa through the cinch 32. Once the liner aa is threaded through the cinch 32, the user will then move the liner aa in a counter clockwise motion around the perimeter of the cinch 32 and into the locking mechanism 34, securing the liner aa to both the container 2 and the handle 4. When the user is ready to release the liner aa from the trash can 1, the user will rotate the liner aa in a clockwise motion simultaneously releasing the liner aa from the locking mechanism 34.

In another exemplary embodiment, the user will twist a portion of the liner aa and thread the liner aa through the cinch 32. The user, depending on the orientation of the thread, may move the liner aa in a clockwise motion around the perimeter of the cinch 32 and into the locking mechanism securing the liner aa to the trash can 1. When the user is ready to release the liner aa, the user will rotate the liner aa in a counter clockwise motion simultaneously releasing the liner aa from the locking mechanism 34.

The above description is only for the specific embodiment of the present invention and is not intended to limit the scope of the present invention. The equivalent changes or modifications made by the structures, features and principles of the present invention should be included in Within the scope of the patent application of the present invention.

What is claimed is:

1. A receptacle comprising:
a side wall;
a bottom wall coupled to the side wall forming a receiving space;
a rim extending around a perimeter of the side wall; and
a handle positioned on opposing sides of the side wall, the handle having a cinch with a locking mechanism on a perimeter of the cinch.

2. The receptacle of claim 1, wherein the locking mechanism is positioned at one end of the cinch forming a wave shape formation within the cinch.

3. The receptacle of claim 2, wherein the handle is positioned under and within the rim.

4. The receptacle of claim 3, wherein the handle further includes a grip.

5. The receptacle of claim 4, wherein the cinch includes a locking position and an unlocking position by rotation.

6. A receptacle comprising:
a side wall;
a bottom wall coupled to the side wall forming a receiving space;
a rim extends around a perimeter of the side wall;
a handle positioned on the side wall; the handle having a cinch with a locking mechanism on a perimeter of the cinch.

7. The receptacle of claim 6, wherein the locking mechanism is positioned at one end of the cinch forming a wave shape formation within the cinch.

8. The receptacle of claim 7, wherein the handle is positioned under the rim.

9. The receptacle of claim 8, wherein the handle further includes a grip.

10. The receptacle of claim 9, wherein the cinch includes a locking position and an unlocking position by rotation.

11. A receptacle comprising:
a body having a receiving space;
a handle coupled to the body; the handle includes a pair of side walls extending from a top portion of the body;
a cinch positioned through each side wall and having a locking mechanism, the locking mechanism positioned at one end of the cinch forming a wave shape formation within the cinch.

12. The receptacle of claim 11, wherein the side walls taper towards the top portion of the body.

13. The receptacle of claim 12, wherein the handle further includes a grip.

14. The receptacle of claim 13, wherein the grip is coupled between a first side wall and a second side wall of the pair of side walls.

15. The receptacle of claim 14, wherein the cinch provides a locking position by threading a liner through the cinch and positioning the liner within the locking mechanism.

16. The receptacle of claim 15, wherein the cinch provides an unlocking position by exiting the liner from the locking mechanism and removing the liner from the cinch.
